(19) United States
(12) Patent Application Publication
(10) Pub. No.: US 2015/0120946 A1
(43) Pub. Date: Apr. 30, 2015

(54) Method, Server and System for a Network Multimedia Content Component Service in an Internet Protocol Multimedia Subsystem

(71) Applicant: Rogier August Caspar Joseph Noldus, Goirle (NL)

(72) Inventor: Rogier August Caspar Joseph Noldus, Goirle (NL)

(73) Assignee: TELEFONAKTIEBOLAGET L M ERICSSON (PUBL), Stockholm (SE)

(21) Appl. No.: 14/366,532

(22) PCT Filed: Dec. 23, 2011
(86) PCT No.: PCT/EP2011/073957

§ 371 Date: Dec. 3, 2014

(51) Int. Cl. H04L 12/24; H04L 29/06

(52) U.S. Cl. CPC H04L 41/0654; H04L 65/1066
USPC 709/228

(57) ABSTRACT

Method, server (13) and system for providing a Network Multimedia Content Component, NMCC, service during a multimedia session (14), between a first party (11) and a second party (12) in an Internet Protocol Multimedia Subsystem, IMS, the multimedia session (14) comprising a plurality of multimedia content components (15, 16), the method comprising the steps of receiving, by the server (13), a network drop message (17) from the IMS network of a network drop of at least one (16′) of the multi-media content components (15, 16) of the multimedia session (14) for the first party (11), and providing, by the server (13), to the first party (11), in response to the network drop message (17), at least one network multimedia content component (18) of a same content type as the at least one dropped multimedia content component (16′).

### FIELD OF THE INVENTION

The present invention relates to content handling in an Internet Protocol Multimedia Subsystem, IMS, and, more particularly, to multimedia content handling between a first and a second party in a session of an IMS network wherein a network multimedia content component is added to the session upon a drop of a multimedia content component of the session.

### BACKGROUND

Growth in transmission capacity of telecommunication networks and the advent in functionality of both fixed and mobile User Equipment, UE, enables the use of further media types than voice only. Amongst others, functionality of transmission of video, for example in a video telephony session, has become available to the users of these networks. Although the technical functionality thereof has been available for many years, implementation and use, however, certainly in mobile telecommunication networks, has yet arrived at the point of take-off. With the recent development in functionality and growth in capacity, video telephony gains increased attention.

The Internet Protocol Multimedia Subsystem, IMS, is an architectural framework for providing such services as video telephony sessions on an Internet Protocol basis. With IMS both voice and multimedia applications can be accessed in a system wherein both fixed and mobile equipment are registered. For providing this service, in IMS use is made of Session Initiation Protocol, SIP. An example of a global standard wherein IMS is implemented is Multimedia telephony, MMTeI.

Within an IMS architecture three layers exist, the transport layer, the control layer and the service layer. Each layer with its own specific purpose. The transport layer for actual access to physical networks, such as, fixed or wireless land lines. The control layer on the other hand controls authentication, routing and distribution of IMS sessions on the basis of SIP. The control layer provides an interface for the service layer with plural services, such as voice, video, text and data. Furthermore, the control layer is arranged for combining services, wherein for example voice is combined with data and video. Herewith plural multimedia components can be transmitted between users in a single IMS session. The third layer, the service layer, is the layer wherein the actual service is transmitted between the parties of the session. Within the service layer a new multimedia component can be initiated during an active IMS session. Also a transfer of a multimedia component of an active IMS session to a further user equipment is possible.

In prior art IMS sessions between a first and a second party plural multimedia components can exist. During these sessions also new multimedia components can be added, or existing multimedia components can drop. Multimedia components can even be transferred from a first User Equipment, UE, to a second UE.

The UE of the first and the second party within the IMS session can be present within a low capacity network such as a second generation, 2G, GSM, network or within a high capacity, third generation, 3G, GSM network. The 2G network capacity is not sufficient to provide full service for all types of multimedia components such as video telephony, the 3G network capacity, however, is sufficient.

Furthermore, IMS provides services to the parties within the IMS network to transfer the session as a whole or in part for a first UE to a second UE. In part, only the voice component is transferred to the second UE, for example. Upon such a transfer the situation can occur that the second UE is not able to receive the video component, for example because the UE is simply not capable, and as a result thereof the video component is dropped from the session.

Upon initiation of the IMS session the first party is unaware of the second party's actual capabilities to receive certain multimedia components. For example, when the first party initiates a call towards the second party with a video telephony capable mobile phone, he or she does not know whether the second party can actually receive the video stream. The second party may be making use of a mobile phone which is unable to receive the video stream.

As such, IMS enables the use of video telephony wherein at least the multimedia component voice and video are present. Because the allocation of bandwidth and the transfer of an active session to further user equipment, UE, within IMS is more flexible than in Global System for Mobile Communications, GSM, networks, IMS provides a platform for the deployment of complex and high bandwidth consuming multimedia component transmission between parties of the IMS network. Within these IMS networks the voice and video multimedia components of the video telephony session are considered just a media component within the IMS network. These media components can at all time be added to the session, dropped from the session or transferred within the session to further UE, e.g. when the calling or called party moves his/her call from a desktop bound phone to a mobile phone.

During initialization of a session within an IMS network a certain bandwidth is allocated for enabling transmission of media components between parties of the session. When establishing transmission of a media component between the parties fails, as a result of a non-capable UE or insufficient capacity for example, the media component is dropped from the session. However, at that time the capacity is already allocated for the session, and that capacity remains unused. In this case the allocated network capacity is released back to the network for availability to future sessions within the IMS network.

In the above stated situation resources of the IMS network, i.e. server resources and network capacity, are allocated and remain unused for the actual intended transfer of media components within an IMS session, resulting in sub-optimal use of resource available within the IMS network. In addition, the above-given example has the effect that the calling party receives a lower user experience than was intended when the call was established.

In view of the large and ever increasing amounts of data conveyed by telecommunications networks nowadays, optimization in terms of capacity on the networks itself and handling capacity by servers becomes of more and more importance. In addition, providing optimum user experience is of increasing importance.

### SUMMARY

It is an object of the present invention to obviate at least some of the above mentioned disadvantages of the prior-art.

It is a further object of the present invention to effectively use already allocated capacity within an IMS session according to a method wherein multimedia component is provided to a first party, in the case the second party is not capable of providing this multimedia component.

In a first aspect a method is provided of a Network Multimedia Content Component, NMCC, service by a server during a multimedia session, between a first party and a second party in an Internet Protocol Multimedia Subsystem, IMS. The multimedia session comprising a plurality of multimedia content components, and comprising the steps of:

receiving, by the server, a network drop message from the IMS network of a network drop of at least one of the multimedia content components of the multimedia session for the first party, and

providing, by the server, to the first party, in response to the network drop message, at least one network multimedia content component of a same content type as the at least one dropped multimedia content component.

With the novel Network Multimedia Content Component, NMCC, service already allocated network capacity does not remain unused, in stead the network capacity is assigned to a network multimedia content component to replace the absent multimedia content component in the session. The network multimedia content component and the multimedia content component are of the same type and, for example, comprise a video stream of a video telephone call. In prior art solutions the video stream is dropped and remains dropped in the session, giving a poor user experience. With the NMCC service a replacement is provided and a video stream remains active, having the advantage of an increased user experience.

As explained above, within the IMS session plural multimedia components can be present, added, dropped or transferred. A drop by the IMS network of a multimedia content component within the IMS session is noticed by generating a network drop message. Such a network drop of at least one of the multimedia content components implies that a requested multimedia component can't be provided in the IMS session or that an active multimedia component is no longer available in the IMS session. The network drop message constitutes a notification about the network drop of the at least one multimedia content components. In prior art solutions however, the multimedia component remains absent in the IMS session. With the NMCC service according to a first aspect of the invention a server receives the network drop message and provides in response thereto a network multimedia content component of the same content type as the dropped multimedia content component, such as voice, video, text, data, real-time video, file transfer, picture, audio, and video-clip component. This has the advantage that the already allocated bandwidth is used by the network multimedia content component which replaces the dropped multimedia content component within the IMS session, therewith increasing network efficiency and user experience.

In another example of the first aspect the step of receiving the network drop message from the IMS network is performed by a first server within the IMS network, and the step of providing the at least one network multimedia content component is performed by a second server within the IMS network.

Upon the drop of a multimedia content component from IMS session the IMS network generates a notice thereof in the form of a network drop message. This network drop message can be generated by a server of the IMS network present in the signalling plane of the IMS session between the two parties, such as a MultiMedia RingBack tone, MMRB, server, a call proxy, a media resource function controller, or by a server present in the media plane of the IMS session, such as a media resource function processor. In an example the network drop message is received by a first server of the IMS network, such as a server active in the signalling plane of the IMS session. The first server then instructs, upon the received network drop message, a second server to provide the network multimedia content component. In yet a further example the second server provides the network multimedia content component via the first server. Therein the second server acts as a storage server for the network multimedia content components.

In a further example the network drop message from the IMS network is received upon a network drop of the at least one multimedia content component of the multimedia session for the first party at initiation of the multimedia session between the first party and the second party.

With IMS, in the control layer a single SIP session can control plural services and multimedia content components. All types of multimedia content components, such as voice, video, real-time video, text, file transfers, pictures, audio, video-clips and the like, can be activated within a single IMS session. No additional sessions are needed or need to be set up to activate a further component. For example when a single IMS session exists, wherein a voice and a video component are active, a text component can be added thereto without setting up a further IMS session. Even other parties or UEs can be added or dropped, to/from a single IMS session.

These multimedia content components can be added at initiation of the IMS session, when a first party initiates a call with a second party, or during an active IMS session, wherein already at least one multimedia content component is active between both parties. In the first example wherein the multimedia content component is added during the initiation of the IMS session the IMS network is arranged for detecting an unsuccessful added multimedia content component. Upon detection, a network drop message is generated to alert further servers within the IMS network of the unsuccessful initiation of the component. In the method according to the further example the network drop message is received when the multimedia content component is unsuccessfully added to an IMS session during initiation of the IMS session itself.

The network drop message can also be received upon unsuccessfully adding a multimedia content component to an already active IMS session wherein at least one further multimedia content component is present.

In yet another example the network drop message from the IMS network is received upon a network drop of the at least one multimedia content component of the multimedia session for the first party at a transfer of the multimedia session from a first User Equipment, UE, of the second party to a second UE of the second party.

As mentioned earlier, a multimedia content component of an active IMS session, or even the IMS session as whole, can be transferred from a first UE to a second UE without dropping the session. If upon such a transfer the first UE of the first party is performing a video telephone conversation with the second party, and the first party transfers the call to his or her second UE, which is not capable of performing video telephone conversations, the video content can not be continued. As a result thereof the network drops the video component from the session due to the incapable second UE, herewith a network drop message is generated. A server according to an aspect of the invention is arranged to provide a network content component to replace the dropped video content. In this case, the second party continues to receive a video component, however, not the original video component from the first party, but in stead a video component provided from the network.

In a further example the plurality of multimedia content components comprises two or more of the group comprising voice component, video component, text component and data component.

The multimedia content components active within the IMS session can be any of the type the IMS session is arranged for, such as, but not restricted to, a voice, video, text, data, real-time video, file transfer, picture, audio, and video-clip component.

In even another example the NMCC service is provided by a server of the IMS network.

An IMS network comprises a plurality of servers, and the NMCC service can be provided either from a server forming part of the IMS network, or from a server from outside the IMS network.

Another example of the first aspect comprises the steps of receiving, by the server, a selection from the first party or the second party, of a multimedia content component to be provided, by the server, to the first party as the network multimedia content component.

The NMCC service can be provided on a registration base. Parties registered to the NMCC service can choose whether a network content component is provided upon a drop of a component from an IMS session. In an example the first party can be registered to the NMCC service and can select which network multimedia content component to be provided to him or her when the original multimedia content component has dropped from the IMS session. In another example the second party can be registered to the NMCC service and can select the network multimedia content component to be provided to the first party when the original multimedia content component has dropped from the IMS session.

In a user portal environment the NMCC server can provide the subscribed user of the service with an overview of components to choose from. The user can select from this overview which component to be added to IMS session upon a drop of a multimedia content component. When the original component drops, due to an incompatible network or UE for example, the NMCC server provides the selected network component to the user to continue the content stream thereto.

In yet another example the server receives a network multimedia content component from a database server, or wherein the network multimedia content component comprises real-time content.

The server arranged for providing the NMCC service does not need to be the same server where the actual content itself is stored. The content can be present on a further server of the IMS network, such as a database server, or more specific an Application Server, AS, or a Media Server, MS, of the IMS network.

In a second aspect there is provided a server comprising a Network Multimedia Content Component, NMCC, engine, for providing an NMCC service during a multimedia session, between a first party and a second party in an Internet Protocol Multimedia Subsystem, IMS, the multimedia session comprising a plurality of multimedia content components, the engine comprising a receiving unit, arranged for receiving a network drop message from the IMS network of a network drop of at least one of the multimedia content components of the multimedia session for the first party, and a content unit, arranged for providing, to the first party, in response to the receiving unit receiving the network drop message, at least one network multimedia content component of a same content type as the at least one dropped multimedia content component.

Such an NMCC engine is applicable with IMS networks wherein the service supports Session Initiation Protocol, SIP, signalling and the UE operates as an IMS based client without modifying the existing network or platform. MMTeI is an implementation of an IMS network wherein the NMCC service can be provided from an Application Server, AS, a Media Server, MS, or another server arranged for applying SIP signalling with IMS based networks.

In a further example of the second aspect, the receiving unit is arranged for receiving the network drop message from the IMS network upon a network drop of the at least one multimedia content components of the multimedia session for the first party at initiation of the multimedia session between the first party and the second party.

In yet another example the receiving unit is arranged for receiving the network drop message from the IMS network upon a network drop of the at least one multimedia content components of the multimedia session for the first party at a transfer of the multimedia session from a first User Equipment, UE, of the second party to a second UE of the second party.

In a further example the plurality of multimedia content components comprises two or more of the group comprising voice component, video component, text component and data component.

In an example the server comprising the NMCC engine is a server of the IMS network.

In a further example the server is an Application Server, AS, and the AS comprises an NMCC engine comprising a receiving unit, arranged for receiving a network drop message from the IMS network, and wherein the engine is arranged for instructing a Media Server, MS, within the IMS network, wherein the MS comprises a content unit, arranged for providing the at least one network multimedia content component upon instructions from the NMCC engine within the application server.

In a third aspect there is provided an Internet Protocol Multimedia Subsystem, IMS, comprising a plurality of servers, at least one server comprising a Network Multimedia Content Component, NMCC, engine, for providing an NMCC service during a multimedia session, between a first party and a second party in an Internet Protocol Multimedia Subsystem, IMS, the multimedia session comprising a plurality of multimedia content components, the engine comprising a receiving unit, arranged for receiving a network drop message from the IMS network of a network drop of at least one of the multimedia content components of the multimedia session for the first party, and a content unit, arranged for providing, to the first party, in response to the receiving unit receiving the network drop message, at least one network multimedia content component of a same content type as the at least one dropped multimedia content component.

### BRIEF DESCRIPTION OF THE DRAWINGS

The present invention will be further discussed in more detail below, using a number exemplary embodiments, with reference to the attached drawing, in which

FIG. 1 schematically illustrates an embodiment with a SIP session comprising multimedia components between two parties of an IMS network;

FIG. 2 schematically illustrates a further embodiment with a SIP session comprising multimedia components between two parties of an IMS network;

FIG. 3 illustrates an embodiment of an IMS network architecture;

FIG. 4 illustrates a sequence diagram for a call within an IMS network embodiment;

FIG. 5 illustrates an embodiment of a server comprising an engine arranged for performing the method steps of the invention.

### DETAILED DESCRIPTION

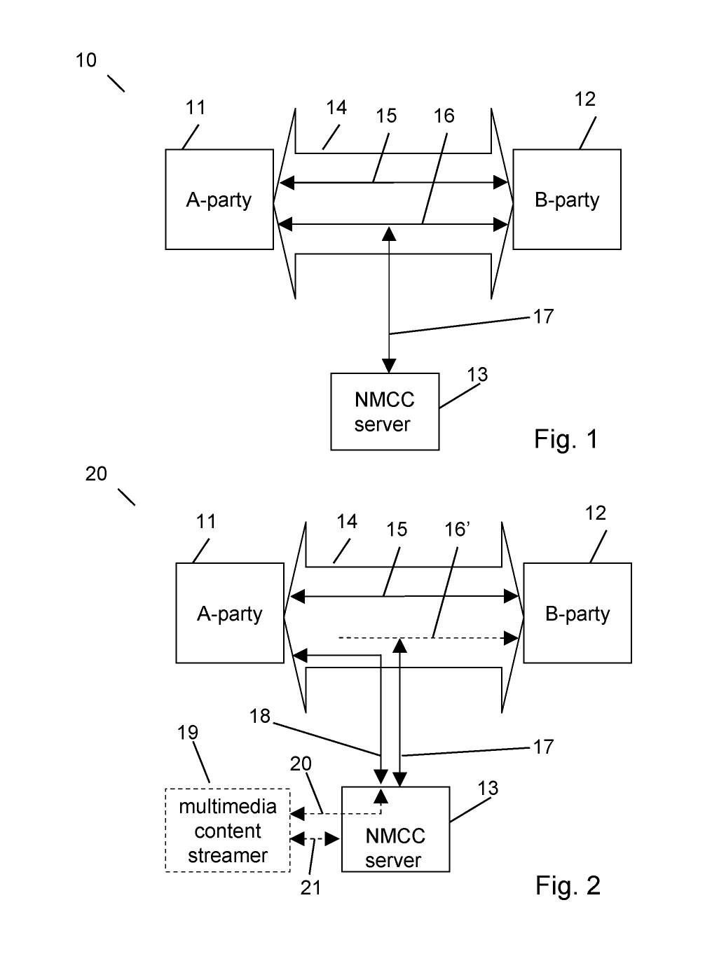

In FIG. 1 an example of the invention 10 is shown wherein an A-party, the calling party, 11 initiates a call towards a B-party 12, the called party, within an IMS environment. Upon start-up of the call a SIP session 14 is initiated between the two parties 11, 12. The SIP session is arranged to comprise plural components 15, 16 within a single session, for example between the A-party 11 and the B-party 12, or between the A-party 11 and further parties (not shown in the figure). In FIG. 1 two components are present between the two parties, a first multimedia content component such as a voice stream 15, and a second multimedia content component such as a video stream 16. The voice 15 and video 16 stream can individually of each other exist within the session 14, meaning that upon a drop of one of the components the other remains active.

If the A-party comprises a mobile User Equipment, UE, capable of performing video telephone calls, and the B-party comprises a fixed UE, also capable of performing video telephone calls, a soft SIP phone, for example, both parties can initiate a video telephone call. When the mobile UE of the A-party is registered within a third generation, 3G, network, he or she can perform the video telephone call with the B-party. Herewith a SIP session is initiated wherein both a voice component as well as a video component are active between the two parties.

Upon initiating the video telephone call between the two parties, plural incompatibilities may arise. The A-party initiating the call towards the B-party is often not aware whether the B-party is capable of receiving the video component of the call. The B-party may at the time of the set-up of the call for example be registered with a voice only UE, registered in a network not capable of performing video streams, or the like.

If the A-party initiates the video telephone call towards the B-party and the B-party is at that moment registered to the IMS network with a voice only UE, the SIP session can only establish the voice component of the call. The video component thereof is dropped from the call by the network. The drop of the component in this case is to be understood as a non-establishment of the component, either at the initiation of the session as a whole, at adding the component to an active/running session or at failure of the component to remain active, for example due to a network error.

The drop of the video component of the session can, as mentioned, also arise from a change of networks. For example, A-party and B-party are in a successful video telephone conversation of a SIP session wherein both a voice and a video component exist. The A-party however performs the call with a mobile UE, capable of performing video telephone conversations, and is registered to a high capacity network such as a 3G network. At a certain moment during the session, the A-party moves from the registered 3G network to a low capacity network 2G network. At that moment the 2G network is unable to service the video component of the session due to the high capacity requirement thereof. As a result thereof the video component is dropped from the session and only the voice component between the two parties remains active.

In an example of the present invention a network multimedia content component, NMCC, server 13 is presented to provide service to parties of an IMS network upon a dropped component of an IMS session. In the situation described above, the IMS network detects the drop of the component from the session and generates a network drop message 17 to inform servers within the IMS network of the dropped component. In the example of the present invention an NMCC server 13 is presented which is arranged to receive the network drop message 17 and to act thereupon. The network drop message 17 triggers the NMCC server 13 to inject a network multimedia content component 18 in the IMS session as a replacement for the dropped multimedia content component 16′. This has the advantage that user experience for the parties active within the IMS session is not reduced. In the example, the dropped video component 16′ is replaced with a video component provided by the network and stored on the NMCC server 13, as shown in FIGS. 1 and 2 or on a further server 19, as shown in FIG. 2, within the network such as a database server, a media server, e.g. a content streamer. The further, second server 19 communicates via 21 with the NMCC server 13 via which communication the NMCC instructs the content streamer 19 to provide a network multimedia content component 20. The network multimedia content component is then injected 20, 18 via the NMCC server 13 into the IMS session 14 to replace the dropped content component 16′. In a further example the media server, i.e. the content streamer 19, can provide the network multimedia content component directly into the IMS session 14, without use of the NMCC server 13.

In the event of a mobile UE of the session being registered to a high capacity, e.g. 3G, network, the invention has the advantage that the considerable amount of allocated network capacity for the session does not remain unused. With the method according to the invention, server resources and network capacity remain efficiently used because as an alternative a network multimedia content component is provided in stead.

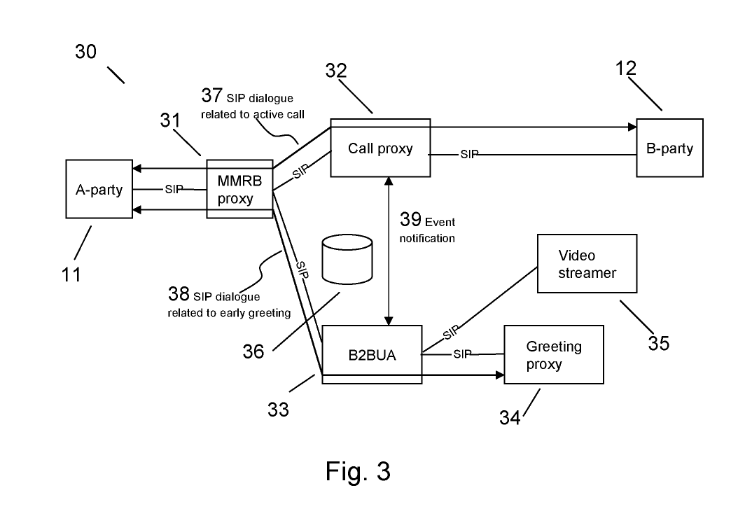

In FIG. 3 an example of IMS network architecture as disclosed wherein an A-party and a B-party are in a video phone conversation.

The method disclosed is an example of how the present invention can be implemented, but is not limited to the use as an enhancement to the prior art service MultiMedia RingBacktone, MMRB. MMRB is a network service based on the IMS network architecture wherein a Personalized Greeting Service, PGS, is present. With this PGS during the alerting phase of the call a MMRB tone is provided by a content server acting under instructions of an application which in its turn is acting on behalf of the B-party. When the B-party answers the call, the multimedia stream provided to the A-party by the MMRB service will be replaced by the multimedia stream provided by the B-party.

Upon the establishment of the video call from the A-party to the B-party and upon registration to MMRB service, the multimedia content used by the PGS may be used as a network multimedia content component to be provided to the A-party if the B-party is unable to answer at least a multimedia content component of the call (i.e. drop of the video component). The A-party will switch over from a video component and a voice component of the MMRB to a video component of the MMRB provided as a network multimedia content component by the personalized greetings system and the voice component by the B-party.

In FIG. 3 an architectural description is shown of a network multimedia content component service, NMCC service implemented as a MMRB service using a personalized greetings system. The implementation comprises a MMRB proxy 31, a Back-To-Back-User Agent, B2BUA 33, a call proxy 32, Video streamer 35 and a personalized greeting system, greeting proxy 34. These SIP servers are arranged for providing the NMCC service for the subscribed party/parties.

The MMRB proxy 31 is arranged for forking an Invite message from an A-party 11 to a B-party 12. This forked Invite message is thereupon received by the B2BUA 33 and contains an indication of the requested MMRB service of the subscriber.

In between the MMRB proxy 31 and the B-party 12 is a call proxy 32 present which in general is arranged to act both as a server and as a client for the purpose of making requests on behalf of other clients. The call proxy 32 acts as a routing server to ensure that a request is sent to another server which is located more close to the B-party. The call proxy interprets and if necessary, rewrites specific parts of a request message before forwarding the request message. Furthermore the call proxy is arranged for sending Event notifications 39 to the B2BUA, for controlling the connection with the greeting proxy 34 and for controlling a multimedia content streamer such as the shown video streamer 35. In this figure a video streamer 35 shown, however, the example is not limited to only a video stream as a network multimedia content component. Wherever in the examples video streamer is shown, in an example of the invention the server is also arranged for streaming other multimedia content components such as voice, text, data, real-time video, file transfer, picture, audio, video-clip component and the like.

In the architectural description shown in FIG. 3, an example of the invention is implemented wherein the NMCC server, with reference number 13 in FIG. 1 and in FIG. 2, is shown as B2BUA 33 in FIG. 3. The B2BUA 33 is arranged to add the network video stream 18, to the call, e.g. the IMS session 14 between the A-party 11 and the B-party 12 as also indicated in FIG. 2. In a further example according to the invention the network video stream, e.g. the network multimedia content component, is injected in the IMS session between the A-party 11 and B-party 12 from a video streamer 35, e.g. the further server 19 shown in FIG. 2. The network multimedia content component is injected upon an Event notification, 39, being the network drop message 17 according to FIG. 2.

The call proxy 32 receives information from the B2BUA 33 about the video stream description from the video streamer 35. Furthermore, as indicated, the call proxy is arranged for adding the video stream to the call when needed. The call proxy 32 however only acts upon receiving a 200 Ok message from the B-party 12.

The B2BUA 33 is the server that establishes the SIP session with the greeting server 34 and with the video streamer 35. It determines from information in the Invite request whether it shall apply PGS service, video stream service or both.

The greeting server 34 is arranged for providing the personalized greeting for alerting phase of the call. It contains control plane functionality and user plane functionality such as providing multimedia content components.

The video streamer 35 finally, being the media server on which the content 18 is stored, and in FIG. 2 indicated as the further server 19, is arranged for providing the video stream during the call, or in another example, a different multimedia content component for the call. It contains therefore both a control plane functionality and a user plane functionality amongst which the providing of multimedia content component for the NMCC service according to the example of the invention.

FIG. 3 presents an embodiment of the invention, which is however not limited to the implementation disclosed there as such, it can also be implemented without existence of a MMRB service.

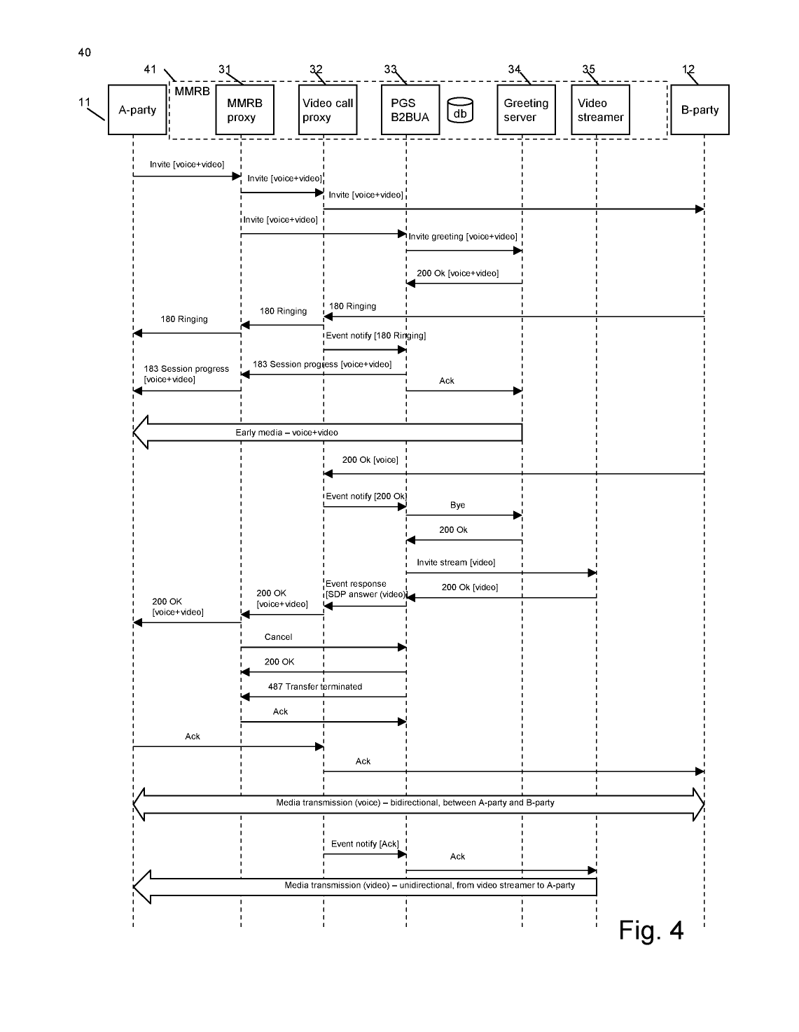

In FIG. 4 a sequence diagram of a communication session according to an example of the invention is disclosed wherein the NMCC service is implemented as a video stream added to a successful call within personalized greeting.

In the call sequence diagram example of FIG. 4 the A-party 11 and the B-party 12 are both SIP subscribers of the same IMS network. Therein the A-party comprises a video phone and the B-party a voice-only SIP phone. The A-party established a video call and the B-party is subscribed to MMRB service.

The triggering of MMRB from the IMS network is according to known techniques and this example of the invention is in accordance therewith. Furthermore the sequence diagram is merely illustrative as for clarity reasons not all sequential steps are disclosed, only the relevant ones for illustrating the NMCC service. The SIP signalling from the MMRB to the B-party and the signalling related to the triggering are not disclosed for example. Although these steps are not disclosed, this does not mean that they are absent in an example of the invention.

Upon establishing a video call an Invite message is routed trough the IMS network and leads to MMRB triggering according to standard MMRB products. The Session Description Protocol, SDP, offer contains a media line for audio and a media line for video. The Invite message is forked by the MMRB proxy 31 towards the B-party 12 and to the B2BUA 33, being 13 in FIG. 2. MMRB proxy adds a route header to the Invite request. The forked Invite message to the B2BUA comprises an added route header identifying the B2BUA, it contains an indication of the requested service for the B-party. The Invite message to the B-party comprises an added route header identifying the call proxy. Upon receiving the Invite from the MMRB proxy 31 the call proxy 32 forwards the Invite message to the B-party.

The B2BUA 33 as implementation example for the NMCC server 13, determines from the added route header that it shall apply personal greeting and NMCC service for this call, if needed. The B2BUA 33 queries the subscriber database to obtain the announcement identifiers, wherein one database query is needed to obtain announcement identifier(s) for personal greeting, and another query for obtaining announcement identifier for video stream 35, 20 of the NMCC service. Thereupon, the B2BUA 33 establishes a SIP Session 14 towards the greeting server 34 in the form of an Invite greeting message. The Invite contains an identifier, such as a R-URI, identifying the required announcement. Subsequently, the 180 Ringing message is forwarded transparently in upstream direction, through call proxy and through MMRB proxy. The traversing of the 180 Ringing through the call proxy 32 leads to the call proxy sending an Event notification to the B2BUA 33. Call proxy knows implicitly the address of the B2BUA as there is a one to one relation between both. Furthermore, there may be other SIP signals passing the call proxy 32, e.g. 183 Session Progress, Prack/200 Ok or Update/200 Ok. All these SIP messages are notified to the B2BUA.

The receiving of the Event notification by the B2BUA has the following effect: The B2BUA sends a 183 Session Progress message towards the A-party which contains the SDP answer received from the greeting server 34. This traverses transparently through MMRB proxy 31 and constitutes a second SIP dialogue. The A-party 11 has, resulting from receiving the 183 Session Progress, information about the SDP answer of the remote party 12 and is now ready to receive early media, in accordance with the SDP answer contained in the 183 Session Progress message. Then, the B2BA sends an Ack message towards the greeting server 34, and the greeting server 34 will thereupon start streaming personal greeting towards the A-party 11. MMRB 41 may be configured to apply reliable provisional response for the 183 Session Progress.

When applying reliable provisional response, B2BUA waits for the Prack before sending the Ack to the greeting server. This has the effect that MMRB has the guarantee that the greeting will arrive after the A-party 11 has received the SDP answer. It is assumed that 180 Ringing from B-party 12 will arrive within the maximum duration of the Invite transaction state model. The greeting server 34 may send one or more retransmissions of the 200 Ok, whilst waiting for the Ack.

The 200 Ok from the B-party traverses the Call proxy 32. The personal greeting needs to be stopped. This is accomplished by sending an Event notification 200 Ok to B2BUA. The Call proxy has no knowledge about the service subscription of the B-party; hence, the Call proxy does not know whether the B-party 12 subscribes to the video streaming service 13. What the Call proxy 32 does know includes: which media streams were included in the SDP offer to B-party 12 and which media streams are included in the SDP answer from B-party 12. For example, the SDP offer indicates voice+video and the SDP answer indicates voice. The B2BUA 32, in its turn, is so far only aware of the media streams included in the SDP offer (voice+video). For that reason, Call proxy 32 shall include in the Event notification 39, being the network drop message 17, to B2BUA 33 information about the media streams 15, 16 in the SDP answer.

When Call proxy 32 has sent the Event notification 39 to B2BUA 33, it shall wait for Event answer from B2BUA 33. B2BUA shall, when receiving the Event notification 200 Ok 39 from Call proxy 32, behave as follows, and this is where the steps for injecting the network multimedia content component start. First, stop the personal greeting. This is done by sending a Bye request to the greeting server. Second, determine whether it has to insert video stream into the call.

In an embodiment, B2BUA 33 will at this point also send a 183 Session Progress towards the A-party 11, to set the media stream to inactive 16′. The criteria for inserting video stream 18 into the call 14 are as follows. The SDP offer contains video; a list of codecs in the m-line (in SDP) that qualify as ‘video’ need to be programmed. Then, the SDP answer does not contain video (video related m-line in SDP answer has its port set to 0). And finally, the subscriber subscribes to video stream service. This follows from aforementioned database query.

If video stream 18 is required, then B2BUA 33 takes the following action. Establish a SIP session 21 towards video streamer 35, 19. The R-URI in the Invite request message for this SIP session contains information about the required video stream 20 for this call 14. Then, include the SDP answer from video streamer 35, 19 into the Event answer. Subsequently include an indication that the B2BUA 33 wants to receive an Event notification 39 for the Ack from the A-party 11 and other SIP messages that traverse the Call proxy 32. Finally, send Event answer to Call proxy 32.

However, if video stream is not required, then B2BUA 33 takes the following action and NMCC service is not provided. Send Event answer to Call proxy 32. The Call proxy 32 will, when receiving the Event answer, behave as follows. If Event answer indicates that SDP adaptation is required and/or that B2BUA 33 wants to receive Event notifications for further SIP messages for the call: apply the SDP adaptation as described in a next section; Send 200 Ok with Record routing.

If Event answer indicates that SDP adaptation is not required and that B2BUA does not want to receive Event notifications for further SIP messages for the call: Send 200 Ok with Record routing. The 200 Ok traverses the MMRB 31 proxy, towards A-party 11. This 200 Ok has the effect that MMRB 31 cancels the SIP session to the B2BUA 33 (Cancel, 200 Ok, 487 Transaction Terminated, Ack).

When the B2BUA 33 has received the Ack from MMRB proxy 31, it behaves as follows. If video stream insertion 18, 20 is required for the call (14): keep the B2BUA process instance active. Then, wait for Event notification Ack to arrive from Call proxy. If video stream insertion, i.e. NMCC injection, is not required for the call: terminate B2BUA process instance.

The Ack from the calling party 11 traverses Call proxy 32. If the Call proxy 32 had received an indication from B2BUA 33 that the B2BUA wants to receive notifications of further SIP messages in the call 14, then the Call proxy 33 sends an Event notification Ack to B2BUA.

When B2BUA 33 receives the Event notification Ack from the Call proxy 32, it sends an Ack message to the video streamer 35. The video streamer 35 starts streaming video 18, 20 towards the calling party 11. It is to be expected that there will be little delay between the 200 Ok from the video streamer and the sending of the Ack to the video streamer. However, the video streamer may retransmit the 200 Ok once or twice.

When A-party 11 or B-party 12 releases the call 14, the Bye request traverses the Call proxy 32. The Call proxy 32 shall then send an Event notification Bye to the B2BUA 33. The B2BUA shall, when receiving the Event notification Bye, release the SIP session with the video streamer 35 (Bye, 200 Ok). The B2BUA 33 process then transits to Idle.

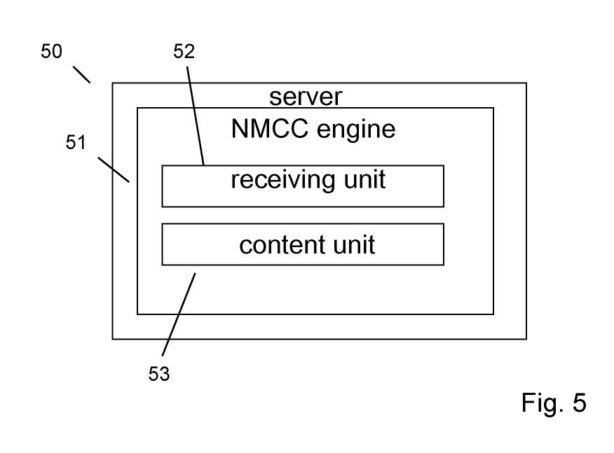

FIG. 5 schematically illustrates a telecommunication server 50 according to an example of the invention. The telecommunication server 50 comprises an NMCC engine 51 for providing, to parties of a session in an IMS, an NMCC service. The engine comprises a receiving unit 52, arranged for receiving a network drop message from the IMS network of a network drop of at least one multimedia content component from the session. It further comprises a content unit 53 for providing to a subscriber of the NMCC service, a network multimedia content component added to the session as a replacement for the dropped multimedia content component of the session. In accordance with an example of the invention, the content unit 53 and the receiving unit 52 can be comprised in different servers within the IMS network.

The skilled person will appreciate that the invention is not limited by the specific embodiments described within this specification and illustrated in the drawings, but may be practised otherwise. The scope of the invention is only determined by the appended claims.

1-15. (canceled)

16. A method of providing a Network Multimedia Content Component (NMCC) service by a server during a multimedia session between a first party and a second party in an Internet Protocol Multimedia Subsystem (IMS) network, said multimedia session comprising a plurality of multimedia content components, the method comprising:
receiving, by said server, a network drop message from said IMS of a network drop of at least one of said multimedia content components of said multimedia session for said first party; and
providing, by said server, to said first party, in response to said network drop message, at least one network multimedia content component of a same content type as said at least one dropped multimedia content component.

17. The method of claim 16, wherein receiving said network drop message from said IMS is performed by a first server within said IMS, and providing said at least one network multimedia content component is performed by a second server within said IMS.

18. The method of claim 16, wherein said network drop message from said IMS is received upon a network drop of said at least one multimedia content component of said multimedia session for said first party at initiation of said multimedia session between said first party and said second party.

19. The method of claim 16, wherein said network drop message from said IMS is received upon a network drop of said at least one multimedia content component of said multimedia session for said first party at a transfer of said multimedia session from a first User Equipment (UE) of said second party to a second UE of said second party.

20. The method of claim 16, wherein said plurality of multimedia content components comprises two or more of the group comprising voice component, video component, text component and data component.

21. The method of claim 16, wherein said NMCC service is provided by a server of said IMS.

22. The method of claim 16, wherein said method further comprises receiving, by said server, a selection from said first party or said second party, of a multimedia content component to be provided, by said server, to said first party as said network multimedia content component.

23. The method of claim 16, wherein said server receives a network multimedia content component from a database server, or wherein said network multimedia content component comprises real time content.

24. A server comprising a Network Multimedia Content Component (NMCC) engine for providing an NMCC service during a multimedia session between a first party and a second party in an Internet Protocol Multimedia Subsystem (IMS), said multimedia session comprising a plurality of multimedia content components, said engine comprising:
a receiving unit configured to receive a network drop message from said IMS of a network drop of at least one of said multimedia content components of said multimedia session for said first party; and
a content unit configured to provide, to said first party, in response to said receiving unit receiving said network drop message, at least one network multimedia content component of a same content type as said at least one dropped multimedia content component.

25. The server of claim 24, wherein said receiving unit is configured to receive said network drop message from said IMS upon a network drop of said at least one multimedia content components of said multimedia session for said first party at initiation of said multimedia session between said first and said second party.

26. The server of claim 24, wherein said receiving unit is configured to receive said network drop message from said IMS upon a network drop of said at least one multimedia content components of said multimedia session for said first party at a transfer of said multimedia session from a first User Equipment (UE) of the second party to a second UE of said second party.

27. The server of claim 24, wherein said plurality of multimedia content components comprises two or more of the group comprising a voice component, video component, text component and data component.

28. The server of claim 24, wherein said server comprising said NMCC engine is a server of said IMS.

29. The server of claim 24, wherein said server is an Application Server (AS) and said AS comprises an NMCC engine comprising a receiving unit configured to receive a network drop message from said IMS, and wherein said engine is configured to instruct a Media Server (MS) within said IMS, wherein said MS comprises a content unit configured to provide said at least one network multimedia content component upon instructions from said NMCC engine within said application server.

30. An Internet Protocol Multimedia Subsystem (IMS) comprising a plurality of servers, at least one server comprising a Network Multimedia Content Component (NMCC) engine for providing an NMCC service during a multimedia session between a first party and a second party in an Internet Protocol Multimedia Subsystem (IMS), said multimedia session comprising a plurality of multimedia content components, said engine comprising:
a receiving unit configured to receive a network drop message from said IMS of a network drop of at least one of said multimedia content components of said multimedia session for said first party; and
a content unit configured to provide, to said first party, in response to said receiving unit receiving said network drop message, at least one network multimedia content component of a same content type as said at least one dropped multimedia content component.
